(19) United States
(12) Patent Application Publication
(10) Pub. No.: US 2019/0219405 A1
(43) Pub. Date: Jul. 18, 2019

(54) UPDATING NAVIGATION DATA

(71) Applicant: Robert Bosch GmbH, Stuttgart (DE)

(72) Inventor: Marlon Ramon Ewert, Untergruppenbach (DE)

(21) Appl. No.: 16/308,102

(22) PCT Filed: May 4, 2017
(86) PCT No.: PCT/EP2017/060656

§ 371 Date: Dec. 7, 2018

(30) Foreign Application Priority Data
Jun. 16, 2016 (DE) 10-2016-210-745.3

(51) Int. Cl. G01C 21/32; G05D 1/02

(52) U.S. Cl. CPC G01C 21/32; G05D 2201/0213; G05D 1/0278; G05D 1/0212

(57) ABSTRACT

A method includes steps for determining a trajectory of a motor vehicle; for scanning surroundings of the motor vehicle along the trajectory; for determining on the basis of the scan that the trajectory extends along a road; for determining on the basis of map data a path between two points of the trajectory; for determining a deviation of the trajectory from the path; and for updating the map data on the basis of the trajectory.

### FIELD OF THE INVENTION

The present invention relates to the update of navigation data. The present invention relates, in particular, to the update of data for the semi-autonomous or autonomous control of a motor vehicle.

### BACKGROUND INFORMATION

A motor vehicle may include a navigation system in order to be guided between an instantaneous position and a target position in a road network. Based on the guidance, the control of the motor vehicle may be carried out semi-autonomously or autonomously. In the semi-autonomous mode, the motor vehicle is steered fully automatically in the longitudinal direction and the transverse direction, however, a driver is available as a monitor and, in case of emergency, as a fall-back level. In the autonomous mode, the guidance of the motor vehicle is no longer monitored by the driver, so that the driver is able to concentrate on another task.

The autonomous or semi-autonomous control of the motor vehicle may be difficult if map data of the navigation system do not coincide with a scan of the surroundings of the motor vehicle. If, for example, the traffic routing is temporarily altered, for example, in the area of a construction site, new roadway construction or if there is a change of traffic regulations in the area of the motor vehicle, a planning of the route on which the motor vehicle is to be guided, and the guidance of the motor vehicle are difficult and errors or unsolvable situations may result.

Thus, the object of the present invention is to specify an improved technology for updating navigation data, in particular, map data.

### SUMMARY

A method includes steps for determining a trajectory of a motor vehicle; for scanning surroundings of the motor vehicle along the trajectory; for determining on the basis of the scan that the trajectory extends along a road; for determining on the basis of map data a path between two points of the trajectory; for determining a deviation of the trajectory from the path; and for updating the map data on the basis of the trajectory.

With the method, it is possible to determine that the motor vehicle is driving on a road, which differs from a known path of the map data. In this case, the road is already recognized as such on the basis of a scan by the motor vehicle, so that the trajectory may be used directly for updating the map data. Hence, the update may take place more rapidly and with improved accuracy. Trajectories that do not represent a road, for example, a drive across a parking facility, across a pedestrian walkway or across a dirt road, may be disregarded in terms of updating the map data. A road, whose course or position has changed, for example, due to environmental influences or to a natural disaster, may be more quickly drivable in an automated manner again with the aid of the motor vehicle.

It is particularly preferred that, on the basis of the scan, it is determined that the use of the road by the motor vehicle is permissible. In this way, an increased protection from the propagation of false or not generally valid map data may be achieved.

It is particularly preferred that the map data are updated only if a multitude of coinciding deviations has been determined. Thus, a single drive on a road under undetermined boundary conditions that already results in an update of the map data may be avoided. The updated map data may be provided to other motor vehicles so that an incorrect update may result in multiple usage of the road.

In one specific embodiment, the update includes a classification of the road. The classification may, for example, include a road type (path, single-lane road, multi-lane road, expressway, etc.), a permitted maximum speed, a no-passing zone or other parameters, which may influence traffic management along the road. In another specific embodiment, the update may also include additional pieces of information relating to surroundings of the road. Such pieces of information may include buildings along the road, street numbers of the buildings, parking facilities along the road, entrances, exits, bus stops, taxi stands, etc.

It is further preferred that the motor vehicle is controlled on the trajectory with the aid of an automated driving function. On the one hand, a scan of the surroundings of the motor vehicle is generally required for the automated driving function, so that an existing control device may be used for scanning the road, on the other hand, such pieces of information, in particular, which are beneficial for the subsequent use of the road by other autonomously or semi-autonomously controlled motor vehicles, may be specifically recorded by the motor vehicle. These may include, for example, position and type of reference points, traffic signs or bumps in the road.

The position of the motor vehicle on the trajectory may be determined with the aid of an augmented satellite navigation system. The satellite navigation system may, for example, include GPS, GLONNAS or Galileo. A receiver for navigation signals from satellites is situated on board the motor vehicle. Additional pieces of information, on the basis of which the position of the motor vehicle may be more accurately determined, may be received either by a satellite or by a terrestrial transmitter. As a result, a highly accurate positioning of the motor vehicle may be carried out, which may be in the range of approximately 1 cm to 2 cm or less.

In another specific embodiment, a position of the motor vehicle on the trajectory is determined with respect to an unchanging reference object, the position of which is known. In contrast to the satellite navigation system, the reference object is usually a ground-based reference object in the field of vision of the motor vehicle. The reference object may, for example, include a prominent building, a water course or a reference point erected specifically for this purpose. The reference object may be visually scanned, for example, and the position of the motor vehicle may be determined on the basis of a distance measurement or with the aid of triangulation. In one specific embodiment, a wireless communication is established between the motor vehicle and the reference object, a travel-time measurement of radio signals between the motor vehicle and the reference object being used to determine a distance. The reference object may, for example, be part of a vehicle-to-infrastructure communication (C2l: Car to infrastructure). In this case, radio signals may be continuously emitted from the reference object. The radio signals may include data that refer to the position of the reference object.

One device on board a motor vehicle includes a positioning unit for determining a trajectory of the motor vehicle; a scanning unit for scanning surroundings of the motor vehicle along the trajectory; and a processing unit, which is configured to determine based on the scan that the trajectory extends along a road; determining on the basis of map data a path between two points of the trajectory; and determining a deviation of the trajectory from the path. An interface is also provided for transmitting pieces of information, in order to enable an update of map data on the basis of the trajectory or of the street.

The device may be designed partially or fully integrated with a device for semi-autonomous or autonomous control of the motor vehicle. In one specific embodiment, the processing unit includes a programmable microcomputer or microcontroller. The method described above may in this case be partially or fully present as a computer program product and may be carried out on the processing unit.

In one specific embodiment, a map memory for the map data is provided on board the motor vehicle. In this embodiment, the map data stored locally may be updated on the basis of the trajectory or on the basis of the road. Pieces of updated information may, however, also be distributed to other motor vehicles.

One system includes the device described above and a central unit, which is configured to receive and to process the pieces of information from multiple motor vehicles. By taking pieces of information from multiple sources or from multiple motor vehicles into account, it is possible to recognize the road with increased reliability. In one specific embodiment, it may also be recognized that the path based on the non-updated map data is no longer driven by any motor vehicle. In this case, a further update of the map data may take place, which marks the path as unpassable or deletes it.

It is preferred that the central unit is configured to transmit updated map data or an update of map data to a motor vehicle. The transmission may take place, in particular, wirelessly, for example, with the aid of a data radio network, a vehicle-to-infrastructure communication or a vehicle-to-vehicle communication. An update of the map data may be increasingly carried out, in particular, locally in the area of the road. The pieces of update information may be transmitted to a multitude of motor vehicles, so that vehicles in the area of the road may be better navigated or automatically or semi-automatically controlled.

### BRIEF DESCRIPTION OF THE DRAWINGS

FIG. 1 depicts a motor vehicle having a control device.

FIG. 2 depicts a flow chart of one method.

FIG. 3 depicts an illustration of the method of FIG. 2.

### DETAILED DESCRIPTION

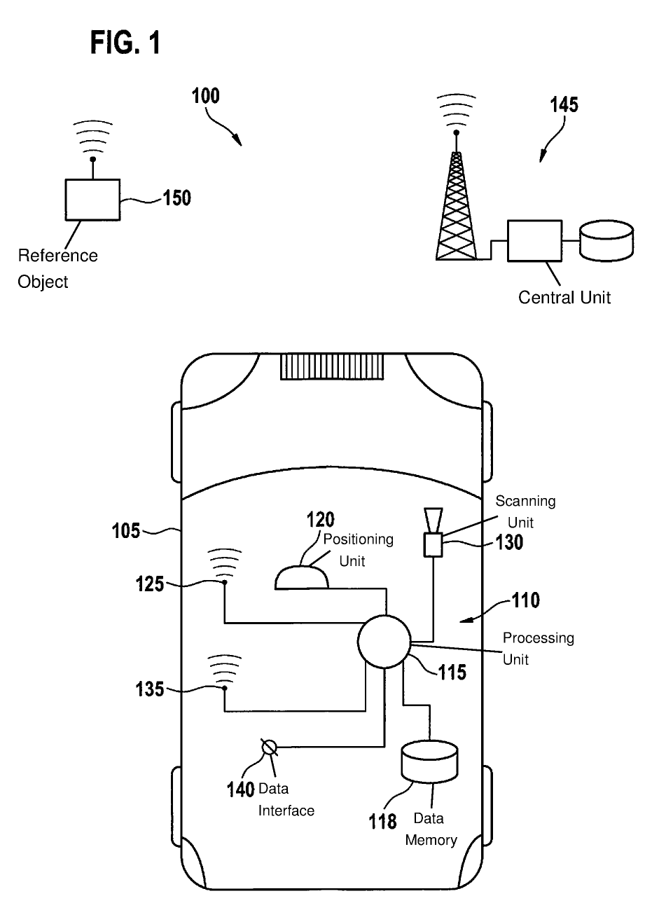

FIG. 1 shows a system 100 for updating navigation data. A device 110 is mounted on board a motor vehicle 105, which includes a processing unit 115, a data memory 118 for navigation data, in particular, in the form of map data with respect to a path network or road network in the area of motor vehicle 105, a positioning unit 120, an optional augmentation unit 125, a scanning unit 130 for scanning surroundings of motor vehicle 105 and, optionally, includes a communication interface 135 or a data interface 140.

System 100 includes device 110 on board motor vehicle 105 as well as a central unit 145, which is configured to communicate with device 110 for processing pieces of information and, preferably, for storing navigation data or map data. The map data usually include pieces of information relating to roads or paths of a traffic network and allow for the planning of an advantageous route between a starting point and a destination point. One position on the map data is clearly assigned to a position of motor vehicle 105 and, on the basis of a particular position of motor vehicle 105, it may usually be determined with the aid of the map data on which section of the road network or path network motor vehicle 105 is located. Navigation data may include additional pieces of information, which may be useful for navigating, for example, places located along a road or a path, potential navigation destinations (hotels, parking garages, restaurants, train stations, etc.) or a no through traffic for a section of the network. Also depicted in FIG. 1 is a reference object 150, which optionally may also be configured for communication with device 110.

Scanning unit 130 is configured to scan surroundings of motor vehicle 105, in particular, with the aid of an optical camera, of a radar system or of a LIDAR system. The scanned pieces of information may be processed by processing unit 115. Positioning unit 120 is configured to determine a position of motor vehicle 105 preferably in the highly accurate range, i.e. with an error of smaller than 5 cm, preferably smaller than 2 cm, further preferably smaller than 1 cm.

For this purpose, positioning unit 120 may include, for example, a receiver for satellite navigation signals. Additional signals for improving the accuracy of the determined position may be received with the aid of augmentation unit 125. In this way, a differential positioning method, for example, may be implemented, which is known as differential GPS.

With the aid of communication interface 135, a wireless communication may take place with another motor vehicle 105, with an infrastructure or directly with central unit 145. In another specific embodiment, the position of the motor vehicle may, for example, also be determined with the aid of a local scan. For this purpose, one or multiple reference objects 150 may be determined in the surroundings of motor vehicle 105 with the aid of scanning unit 130. If the positions of reference objects 150 are known, it is then possible to determine the position of motor vehicle 105 on the basis of the distances to reference objects 150 or on the basis of the perceived angles between reference objects 150. A distance to a reference object 150 may be measured with the aid of wireless signals. For this purpose, reference object 150 may be configured for wireless communication. In one specific embodiment, reference object 150 in this case transmits radio waves, onto which a piece of information is modulated that refers to the position of reference object 150. Reference object 150 may be part of a vehicle-to-infrastructure system. In this case, reference object 150 may also forward a wireless communication with device 110 to central unit 145. The forwarding may take place via a wireless or hard-wired network, which may be part of the Internet.

With the aid of interface 140, processing unit 115 may, in particular, scan a driving mode, a driving parameter or an intended maneuver of motor vehicle 105. For this purpose, data interface 140 is preferably connected to one or multiple systems on board motor vehicle 105.

It is provided that device 110 is designed in such a way that a deviation of the actual trajectory of motor vehicle 105 from a path known in data memory 118 is detected and analyzed, in order to form the basis for a potential adaptation of map data in data memory 118.

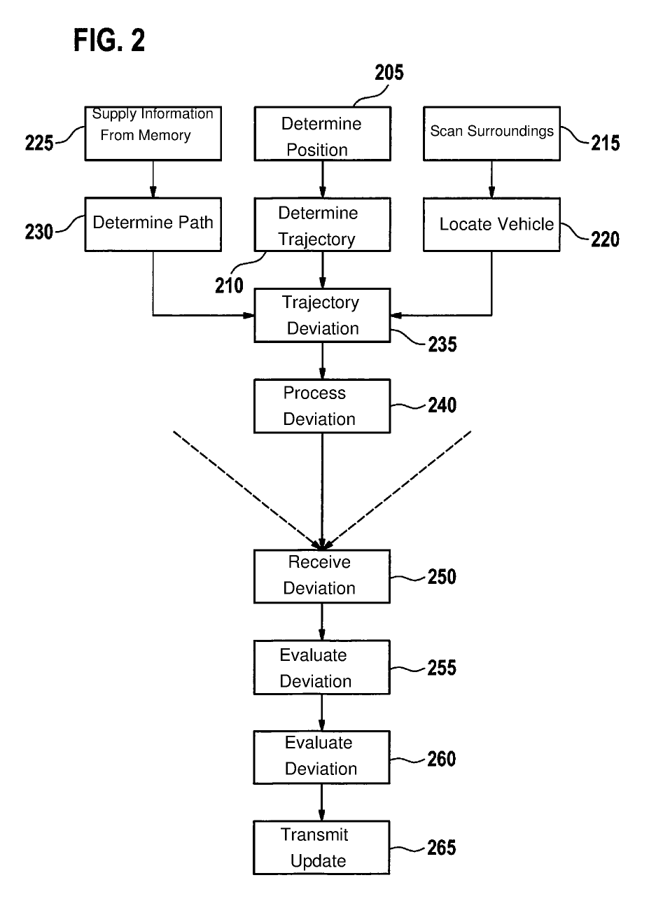

FIG. 2 shows a flow chart of a method 200. Method 200 is designed, in particular, for updating map data. In a step 205, a position of motor vehicle 105 is determined. On the basis of the position, a trajectory of motor vehicle 105 is determined. In a step 215, surroundings of motor vehicle are scanned, preferably, parallel with the position determination in step 205. On the basis of the scan, it is determined in a step 220 that motor vehicle 105 is located on a road. A road in this case is defined as a paved path, which is connected to a path network that is stored in data memory 118. Additional criteria for the classification of surroundings of motor vehicle 105 as a road may include indications that the road is suitable for repeated use by a motor vehicle 105. For example, a roadway marking, a traffic sign or a traffic light may be indications for a road.

In a step 225, pieces of information with respect to paths in the area of motor vehicle 105 are supplied from data memory 118. If the position of motor vehicle 105 deviates from the positions of the courses of all known paths, motor vehicle 105 may then be located on an unknown road. It is preferred that in a step 230 a path is determined, which ought to have been traveled by motor vehicle 105 based on the map data in data memory 118. For this purpose, it may be determined, in particular, in which section the trajectory differs from the known paths. The deviation of the trajectory from one or multiple paths is carried out in a step 235.

Map data for motor vehicle 105 may be directly updated on the basis of the deviation. However, it is preferred that the deviation determined by motor vehicle 105 is transmitted to central unit 145 and further processed there in a step 240.

In a step 250, the deviation from step 240 is received. Still other deviations may also be received, which have been determined by other motor vehicles 105. In a step 255, the received deviations are evaluated. In the process, it may be considered, in particular, that a change of a potential traffic routing is likely, in particular, if it has been determined at the same location by multiple vehicles. The received deviations are evaluated in a step 260. In the process, a plausibility of the received deviations is preferably checked by comparing the data with one another. Implausible pieces of information may be rejected. The update may be carried out directly on the map data that are stored by central unit 145. This is advantageous, for example, if step 225 includes a retrieval of map data from central unit 145. In another preferred specific embodiment, an update is transmitted to motor vehicle 105 in a step 265 and added to local data memory 118. In this case, the update may include an addition or a deletion of a road or of a traffic junction. In the event a road is relocated, for example, due to a construction site, an old road may be deleted and a new road may be added. Changing a road routing is plausible, in particular, if the deviation of the trajectory of motor vehicle 105 from the nearest path is minimal. The difference may, for example, be smaller than the road width or below a predetermined threshold value. The threshold value may, for example, be 10 m 20 m or 50 m.

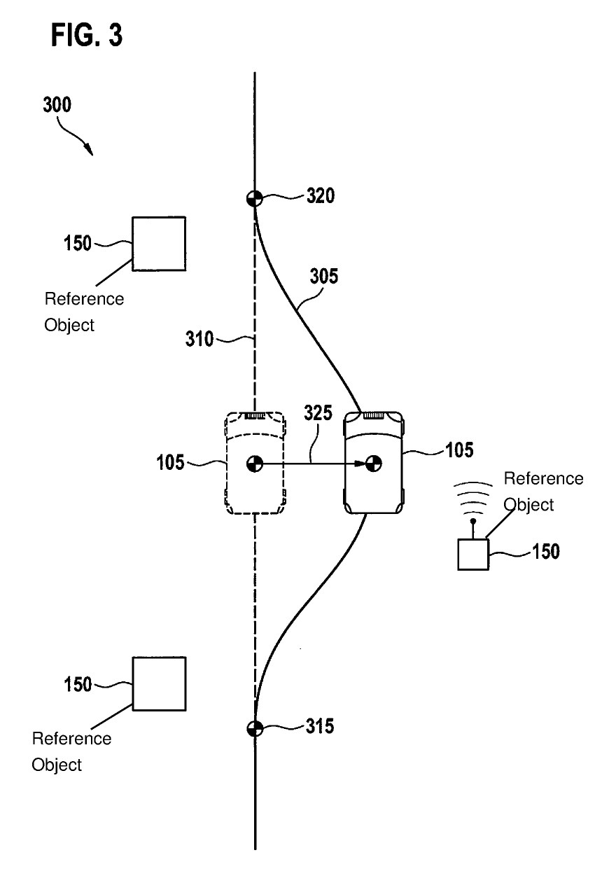

FIG. 3 shows an illustration 300 of method 200 of FIG. 2. Motor vehicle 105 is located on a trajectory 305, which is depicted by a solid line. A nearest path 310 describes another trajectory, which motor vehicle 105 would have to take if it were located only on paths that are noted in data memory 118. Path 310 is part of a traffic network, about which pieces of information are saved in data memory 118. Trajectory 305 deviates in one section between a first point 315 and a second point 320 of path 310. A maximum deviation is plotted as arrow 325.

If motor vehicle 105 determines that trajectory 305 extends on a road, the map data in data memory 118 may then be modified to the extent that the new road is added to the data. Old path 310 may be deleted from the map data if it is no longer used over a predetermined period of time. The deletion may also take place if deviation 325 is below a predetermined threshold value. Path 310 may also be deleted if it is established with the aid of scanning unit 130 that it no longer exists or driving on it is no longer permissible.

The position of motor vehicle 105 may, as was described in greater detail above, be determined with respect to one or to multiple reference objects 150. In another specific embodiment, pieces of information relating to one or multiple reference objects 150 may be recorded by scanning unit 130 and saved as pieces of surroundings information in data memory 118. Outdated pieces of surroundings information may be deleted in the process.

1.-10. (canceled)

11. A method, comprising:
determining a trajectory of a motor vehicle;
scanning surroundings of the motor vehicle along the trajectory;
determining on the basis of the scanning that the trajectory extends along a road;
determining on the basis of map data a path between two points of the trajectory;
determining a deviation of the trajectory from the path; and
updating the map data on the basis of the trajectory.

12. The method as recited in claim 11, further comprising determining on the basis of the scanning that a use of the road by the motor vehicle is permissible.

13. The method as recited in claim 11, wherein the map data is updated only if a multitude of coinciding deviations have been determined.

14. The method as recited in claim 11, wherein the updating includes classifying the road.

15. The method as recited in claim 11, further comprising steering the motor vehicle on the trajectory with the aid of an automated driving function.

16. The method as recited in claim 11, further comprising determining a position of the motor vehicle on the trajectory with the aid of an augmented satellite navigation system.

17. The method as recited in claim 11, further comprising determining a position of the motor vehicle on the trajectory determined with respect to an unchangeable reference object having a known position.

18. A device on board a motor vehicle, comprising:
a positioning unit for determining a trajectory of the motor vehicle;
a scanning unit for scanning surroundings of the motor vehicle along the trajectory;
a processing unit configured:
to determine on the basis of the scanning that the trajectory extends along a road,
to determine on the basis of map data a path between two points of the trajectory, and
to determine a deviation of the trajectory from the path; and
an interface for transmitting pieces of information, in order to enable an update of the map data on the basis of the trajectory.

19. A system, comprising:
a device including:
a positioning unit for determining a trajectory of a motor vehicle;
a scanning unit for scanning surroundings of the motor vehicle along the trajectory;
a processing unit configured:
to determine on the basis of the scanning that the trajectory extends along a road,
to determine on the basis of map data a path between two points of the trajectory, and
to determine a deviation of the trajectory from the path; and
an interface for transmitting pieces of information, in order to enable an update of the map data on the basis of the trajectory; and
a central unit configured to receive and to process the pieces of information from multiple motor vehicles.

20. The system as recited in claim 19, wherein the central unit is configured to transmit one of updated map data and an update of map data to the motor vehicle.
